(19) United States
(12) Patent Application Publication
(10) Pub. No.: US 2014/0286639 A1
(43) Pub. Date: Sep. 25, 2014

(54) METHOD FOR DATA COMMUNICATION IN OPTICAL NETWORK SYSTEM, OPTICAL LINE TERMINAL, AND OPTICAL NETWORK SYSTEM

(71) Applicant: Huawei Technologies Co., Ltd., Shenzhen (CN)

(72) Inventors: Jin Li, Shenzhen (CN); Yunshi Wang, Shenzhen (CN)

(21) Appl. No.: 14/299,640

(22) Filed: Jun. 9, 2014

Related U.S. Application Data
(63) Continuation of application No. PCT/CN2011/083752, filed on Dec. 9, 2011.

(51) Int. Cl. H04B 10/27

(52) U.S. Cl. CPC H04B 10/27
USPC 398/66

(57) ABSTRACT

The present invention provides a method: sending a downlink message to an optical network terminal through a first port of an optical line terminal; receiving, from a second port of the optical line terminal, an uplink message returned by the optical network terminal; obtaining a second time of receiving the uplink message, and obtaining a first time when the uplink message reaches the first port; according to the first time and the second time, obtaining an equalized delay from the second port to the optical network terminal; and after the optical line terminal is switched from the first port to the second port, delivering, by the optical line terminal, the equalized delay from the second port, and performing data communication with the optical network terminal through the second port. In the present invention processing time is decreased to a maximum extent, and stability of the system is improved.

### CROSS-REFERENCE TO RELATED APPLICATIONS

This application is a continuation of International Application No. PCT/CN2011/083752, filed on Dec. 9, 2011, which is hereby incorporated by reference in its entirety.

### TECHNICAL FIELD

Embodiments of the present invention relate to the field of communications technologies, and in particular, to a data communication method of an optical network system, an optical line terminal, and the optical network system.

### BACKGROUND

Because of advantages such as stable and reliable operation, the passive optical network (Passive Optical Network, PON) is widely applied in recent years.

Specific architecture of an existing PON is that: PON ports of an optical line terminal (optical line terminal, OLT) located at a central control station are connected, through an optical distribution network (Optical Distribution Network, ODN), to PON ports of some optical network terminals (Optical Network terminal, ONT) to form service paths, where the ODN includes a backbone optical fiber and a passive optical splitter or a coupler. Because the number of the optical network terminals connected to PON ports of each optical line terminal through the backbone optical fiber is large, a system fails to work normally when a failure occurs. Therefore, in the prior art, a second port of the optical line terminal and a corresponding backbone optical fiber are configured for protection. When a first port of the optical line terminal works normally, each optical network terminal sends a cell according to a delay time delivered by the first port, the first port of the optical line terminal makes a response to the received cell and the second port does not make a response but only performs information synchronization. When a failure occurs on the first port of the optical line terminal, the second port of the optical line terminal, in place of the first port of the optical line terminal, continues to send an optical signal to a corresponding optical network terminal and process a cell sent by the optical network terminal.

However, in the prior art, communication needs to be interrupted when the second port takes the place of the first port to continue work, and the more the optical network terminals are, the longer a communication interruption time is. If the optical network terminal does not restore the communication with the second port within a preset time, it causes a service interruption of the optical network terminal.

### SUMMARY

For the foregoing defect of the prior art, embodiments of the present invention provide a data communication method of an optical network system, an optical line terminal, and the optical network system.

In one aspect, an embodiment of the present invention provides a method for data communication in an optical network system, including:

an optical line terminal in the optical network system is connected to at least one optical network terminal through a first port and a second port, where the data communication method includes:

sending a downlink message to the optical network terminal through the first port; receiving, from the second port, an uplink message returned by the optical network terminal, obtaining a second time of receiving the uplink message, and obtaining a first time when the uplink message reaches the first port;

according to the first time and the second time, obtaining an equalized delay from the second port to the optical network terminal; and

after the optical line terminal is switched from the first port to the second port, delivering, by the optical line terminal, the equalized delay from the second port, and performing data communication with the optical network terminal through the second port.

In another aspect, an embodiment of the present invention provides an optical line terminal, including:

a first processing unit and a second processing unit, where:

the first processing unit is connected to at least one optical network terminal through a first port, and is configured to send, through the first port, a downlink message to the optical network terminal; and the second processing unit is connected to the at least one optical network terminal through a second port, and is configured to receive, from the second port, an uplink message returned by the optical network terminal, obtain a second time of receiving the uplink message, and obtain a first time when the uplink message reaches the first port, and obtain an equalized delay from the second port to the optical network terminal according to the first time and the second time, where after the optical line terminal is switched from the first port to the second port, the optical line terminal delivers the equalized delay from the second port, and performs data communication with the optical network terminal through the second port.

In still another aspect, an embodiment of the present invention provides an optical network system, where the system includes:

an optical line terminal and an optical network terminal, where:

the optical line terminal is connected to at least one optical network terminal through a first port and a second port and is configured to send a downlink message to the optical network terminal through the first port, receive, from the second port, an uplink message returned by the optical network terminal, obtain a second time of receiving the uplink message, and obtain a first time when the uplink message reaches the first port, and obtain an equalized delay from the second port to the optical network terminal according to the first time and the second time; and after the optical line terminal is switched from the first port to the second port, the optical line terminal delivers the equalized delay from the second port, and performs data communication with the optical network terminal through the second port.

According to the data communication method of the optical network system, the optical line terminal, and the optical network system provided in the embodiments of the present invention, when the optical line terminal sends the downlink message to the optical network terminal through the first port, the second time is received from the second port, where the second time is time when the uplink message returned by the optical network terminal reaches the second port, and the first time when the uplink message reaches the first port is obtained, so as to obtain the equalized delay from the second port to the optical network terminal according to the first time and the second time; and after being switched from the first port to the second port, the optical line terminal may directly deliver the equalized delay to the optical network terminal from the second port, which is different from that ranging must be performed again on an optical network terminal in the prior art, so that the optical line terminal performs the data communication with the optical network terminal through the second port. Therefore, when the second port takes the place of the first port to continue work, fast switchover between ports is implemented, processing time is reduced to a maximum extent, and stability of the system is improved.

### BRIEF DESCRIPTION OF THE DRAWINGS

To illustrate the technical solutions in the embodiments of the present invention or in the prior art more clearly, the following briefly describes accompanying drawings required for describing the embodiments or the prior art. Obviously, the accompanying drawings in the following description are some embodiments of the present invention, and persons of ordinary skill in the art may obtain other drawings from these accompanying drawings without making creative efforts.

FIG. 1 is a flow chart of a data communication method of an optical network system according to an embodiment of the present invention;

FIG. 2 is a flow chart of a data communication method of an optical network system according to another embodiment of the present invention; and

FIG. 3 is a schematic structural diagram of an optical network system according to an embodiment of the present invention.

### DETAILED DESCRIPTION

To make the objectives, technical solutions, and advantages of the present invention more clear, the following clearly and completely describes the technical solutions according to the embodiments of the present invention with reference to the accompanying drawings in the embodiments of the present invention. Obviously, the described embodiments are part of rather than all of the embodiments of the present invention. All other embodiments obtained by persons of ordinary skill in the art based on the embodiments of the present invention without making creative efforts shall fall within the protection scope of the present invention.

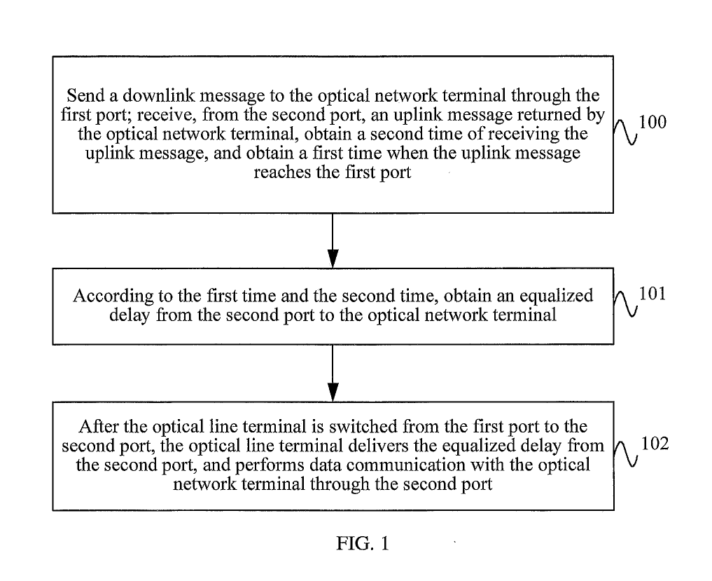

FIG. 1 is a flow chart of a data communication method of an optical network system according to an embodiment of the present invention. An optical line terminal in the optical network system in the method embodiment shown in FIG. 1 is connected to at least one optical network terminal through a first port and a second port, and the data communication method includes:

Step 100: Send a downlink message to the optical network terminal through the first port; receive, from the second port, an uplink message returned by the optical network terminal, obtain a second time of receiving the uplink message, and obtain a first time when the uplink message reaches the first port.

The optical line terminal in the optical network system sends the downlink message to the optical network terminal (the optical network terminal in the embodiment of the present invention may also be an optical network unit) through the first port, and the optical network terminal obtains, according to the received downlink message, an equivalent delay from the optical network terminal to the first port, where the optical network terminal is connected to the optical line terminal, so that the optical network terminal controls, according to the equivalent delay, a sending time of returning the uplink message to the optical line terminal.

After delaying a time specified by the equivalent delay, the optical network terminal sends the uplink message to the optical line terminal. The first port and the second port of the optical line terminal both receive the uplink message sent by the optical network terminal. Because a distance between the first port and the optical network terminal is different from that between the second port and the optical network terminal, the time when the uplink message sent by the optical network terminal reaches the first port is different from the time when the uplink message sent by the optical network terminal reaches the second port. Because the optical network terminal controls, according to the equivalent delay sent by the first port, the sending time of the uplink message, the uplink message does not collide with an uplink message sent by another optical network terminal when reaching the first port, so that the first port makes a response to the received uplink message.

The second port of the optical network terminal receives the uplink message returned by the optical network terminal at the second time to record the second time, and obtain the first time when the uplink message reaches the first port.

Step 101: According to the first time and the second time, obtain an equalized delay from the second port to the optical network terminal.

The second port of the optical network terminal obtains the equalized delay from the second port to the optical network terminal according to the first time when the uplink message reaches the first port and the second time when the uplink message reaches the second port. The equalized delay is equal to an optical path length difference between the first port and the second port, that is to say, a difference between an equivalent delay that the first port, when working normally, allocates to the optical network terminal and an equivalent delay that the second port, when working normally, allocates to the optical network terminal.

Step 102: After the optical line terminal is switched from the first port to the second port, the optical line terminal delivers the equalized delay from the second port, and performs data communication with the optical network terminal through the second port.

When the first port fails to work normally, switchover between the first port and the second port needs to be performed, so as to enable the second port to take the place of the first port to work and continue to process the received uplink message. Because of a certain time difference of receiving the uplink message by the first port and the second port, if the optical network terminal continues controlling, according to the equivalent delay delivered by the first port, the sending time when sending the uplink message, a collision might occur when the uplink message reaches the second port. Therefore, the optical line terminal delivers, through the second port, the obtained equalized delay to the optical network terminal, and performs the data communication with the optical network terminal through the second port, so that the optical network terminal adjusts, according to the equalized delay, the time of sending the uplink message, thereby preventing the sent uplink message from colliding with an uplink messages sent by another optical network terminal when reaching the second port.

In the prior art, when the first port of the optical line terminal fails to work normally and after the second port takes the place of the first port to work, the second port needs to perform ranging on all optical network terminals again by using a ranging technology, so as to obtain a new equivalent delay to control the time of sending the uplink message by the optical network terminal. Because the ranging procedure consumes time, the more the optical network terminals are, the longer a communication interruption time is, and a service interruption might be caused in a severe case. Compared with the prior art, according to the data communication method of the optical network system provided in the embodiment, in a case that the first port works normally, the second port obtains the second time when the uplink message reaches the second port and the first time when the uplink message reaches the first port, and obtains the equalized delay from the second port to the optical network terminal according to the first time and the second time; and after the switchover from the first port to the second port, the optical line terminal delivers the equalized delay to the optical network terminal form the second port, so as to control the time when the uplink message sent by the optical network terminal reaches the second port and avoid that the second port performs ranging again on all the optical network terminals to obtain a new equivalent delay, thereby saving a large amount of time, implementing fast switchover between ports, reducing processing time to a maximum extent, and improving stability of the system.

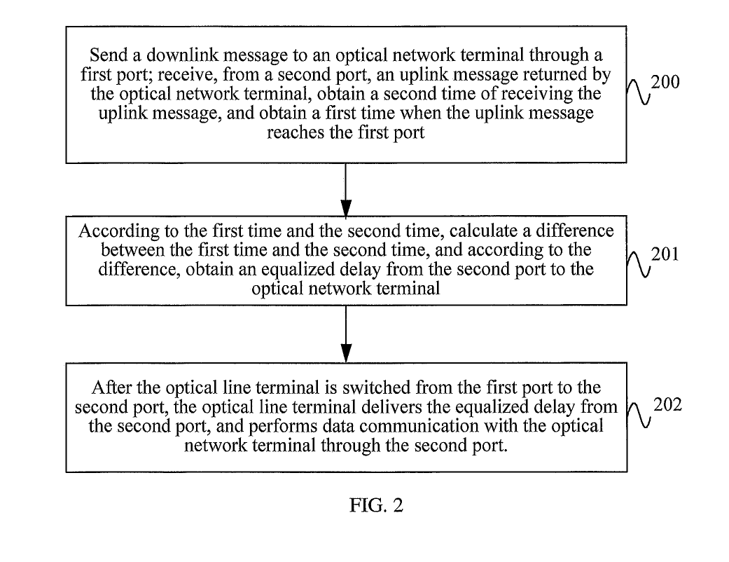

FIG. 2 is a flow chart of a data communication method of an optical network system according to another embodiment of the present invention. As shown in FIG. 2, the method includes:

Step 200: Send a downlink message to an optical network terminal through a first port; receive, from a second port, an uplink message returned by the optical network terminal, obtain a second time of receiving the uplink message, and obtain a first time when the uplink message reaches the first port.

Reference may be made to step 100 in the embodiment shown in FIG. 1 for the specific implementation procedure of step 200 in this embodiment, which is not repeatedly described here. It should be noted that, selection may be performed according to software and hardware of the system for that the second port of an optical line terminal obtains the first time when the uplink message reaches the first port, which is not specifically limited in this embodiment, and only two specific application scenarios are used for specific description.

Scenario 1: The first port and the second port that are applicable to the optical line terminal are located at one same control board or different control boards of the optical line terminal.

Step (1): The optical line terminal sends the downlink message, which carries the first time, to the optical network terminal through the first port, where the first time is the time when the uplink message sent by the optical network terminal reaches the first port.

Step (2): The optical network terminal returns the uplink message including the first time.

Step (3): The second port receives the uplink message returned by the optical network terminal, and parses the uplink message to obtain the first time when the uplink message reaches the first port.

Scenario 2: The first port and the second port that are applicable to the optical line terminal are located at one same control board of the optical line terminal.

Step (1): The first port receives the uplink message returned by the optical network terminal and obtains the first time of receiving the uplink message.

Step (2): The first port sends, to the second port, a notification message that carries the first time.

Step (3): The second port receives and parses the notification message sent by the first port to obtain the first time when the uplink message reaches the first port.

Step 201: According to the first time and the second time, calculate a difference between the first time and the second time, and according to the difference, obtain an equalized delay from the second port to the optical network terminal.

The second port of the optical network terminal calculates the difference between the first time and the second time according to the first time when the uplink message reaches the first port and the second time when the uplink message reaches the second port, and obtains the equalized delay from the second port to the optical network terminal according to the difference. The equalized delay is equal to an optical path length difference between the first port and the second port, that is to say, a difference between an equivalent delay that the first port, when working normally, allocates to the optical network terminal and an equivalent delay that the second port, when working normally, allocates to the optical network terminal. It should be noted that, in this embodiment, the difference between the first time and the second time may be set to a difference of the first time minus the second time, or set to a difference of the second time minus the first time.

Step 202: After the optical line terminal is switched from the first port to the second port, the optical line terminal delivers the equalized delay from the second port, and performs data communication with the optical network terminal through the second port.

When the first port fails to work normally, switchover needs to be performed between the first port and the second port, so that the second port takes the place of the first port to work and continue to process the received uplink message. The optical line terminal delivers the obtained equalized delay to the optical network terminal through the second port, and performs the data communication with the optical network terminal through the second port; and the optical network terminal adjusts, according to the equalized delay, the time of sending the uplink message, that is, whether to increase the equivalent delay of sending the uplink message or decrease the equivalent delay of sending the uplink message according to the equalized delay should be adjusted according to a specific situation, so that the sent uplink message does not collide with an uplink message sent by another optical network terminal when reaching the second port.

According to the data communication method of the optical network system provided in the embodiment, in a case that the first port works normally, the second port obtains the second time when the uplink message reaches the local and the first time when the uplink message reaches the first port, where a specific implementation manner that the second port obtains the first time when the uplink message reaches the first port may be set according to specific application scenarios, and the second port obtains the equalized delay from the second port to the optical network terminal according to the difference between the first time and the second time; and after the switchover from the first port to the second port, the optical line terminal delivers the equalized delay to the optical network terminal from the second port, so as to control the time when the uplink message sent by the optical network terminal reaches the second port, thereby avoiding that the second port performs ranging again on all optical network terminals to obtain a new equivalent delay, saving a great amount of time, implementing fast switchover between ports, reducing processing time to a maximum extent, and improving stability of a system.

Persons of ordinary skill in the art may understand that all of or part of the steps of the methods embodiments may be implemented by a program instructing relevant hardware. The program may be stored in a computer readable storage medium. When the program runs, the foregoing steps of the methods embodiments are performed. The storage medium may be any medium that may store program codes, such as a ROM, a RAM, a magnetic disk, or a compact disk, and the like.

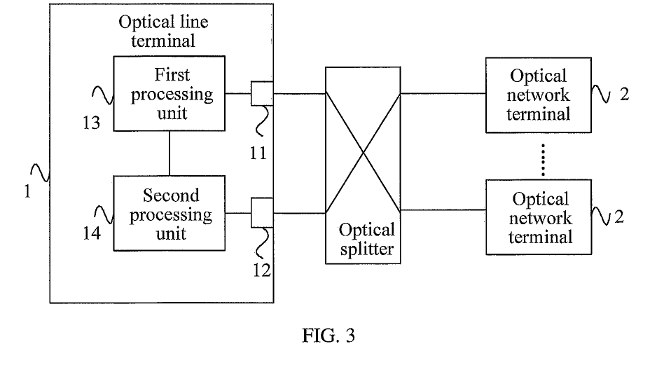

FIG. 3 is a schematic structural diagram of an optical network system according to an embodiment of the present invention. As shown in FIG. 3, the system includes an optical line terminal 1 and an optical network terminal 2, where the optical line terminal 1 is connected to at least one optical network terminal 2 through a first port 11 and a second port 12, and the optical line terminal 1 is configured to send a downlink message to the optical network terminal 2 through the first port 11, receive, from the second port 12, an uplink message returned by the optical network terminal 2, obtain a second time of receiving the uplink message, and obtain a first time when the uplink message reaches the first port, and obtain an equalized delay from the second port 12 to the optical network terminal 2 according to the first time and the second time; and after the optical line terminal 1 is switched from the first port 11 to the second port 12, the optical line terminal 1 delivers, from the second port 12, the obtained equalized delay and performs data communication with the optical network terminal 2 through the second port 12.

Reference may be to the foregoing method embodiment shown in FIG. 1 for a function and processing process of each module in the optical network system provided in this embodiment, and its implementation principle and technical effect are similar, which are not repeatedly described here.

Based on the foregoing embodiments, specifically, a manner that the second port 12 of the optical line terminal 1 obtains the first time when the uplink message reaches the first port 11 may be selected according to software and hardware of the system, which is not specifically limited in the embodiment, and only two specific application scenarios are used for specific description.

When the first port 11 and the second port 12 of the optical line terminal 1 are located at one same control board or at different control boards of the optical line terminal 1, the optical line terminal 1 is configured to send the downlink message, which carries the first time, to the optical network terminal 2 through the first port 11, where the first time is the time when the uplink message sent by the optical network terminal 2 reaches the first port 11; the optical network terminal 2 is configured to return the uplink message including the first time; and the second port 12 is configured to receive the uplink message returned by the optical network terminal 2, and parse the uplink message to obtain the first time when the uplink message reaches the first port 11.

When the first port 11 and the second port 12 of the optical line terminal 1 are located at one same control board of the optical line terminal, the first port 11 is configured to receive the uplink message returned by the optical network terminal 2, obtain the first time of receiving the uplink message, and send, to the second port 12, a notification message that carries the first time; and the second port 12 is configured to receive and parse the notification message sent by the first port 11 to obtain the first time when the uplink message reaches the first port 11.

Specifically, the second port 12 of the optical network terminal 1 is configured to calculate, according to the first time when the uplink message reaches the first port 11 and the second time when the uplink message reaches the second port 12, a difference between the first time and the second time, and obtain the equalized delay from the second port 12 to the optical network terminal 2 according to the difference. It should be noted that, in this embodiment, the difference between the first time and the second time may be set to a difference of the first time minus the second time, or set to a difference of the second time minus the first time.

Reference may made be to the foregoing method embodiment shown in FIG. 2 for the function and processing process of each module in the optical network system provided in this embodiment, and its implementation principle and technical effect are similar, which are not repeatedly described here.

Referring to the schematic structural diagram of the optical network system shown in FIG. 3, the optical line terminal 1 includes a first processing unit 13 and a second processing unit 14, where the first processing unit 13 is connected to at least one optical network terminal 2 through the first port 11, and is configured to send a downlink message to the optical network terminal 2 through the first port 11; and the second processing unit 14 is connected to at least one optical network terminal 2 through the second port 12, and is configured to receive, from the second port 12, an uplink message returned by the optical network terminal 2, obtain a second time of receiving the uplink message, and obtain a first time when the uplink message reaches the first port 11; and obtain an equalized delay from the second port 12 to the optical network terminal 2 according to the first time and the second time; and after the optical line terminal 1 is switched from the first port 11 to the second port 12, the optical line terminal delivers, from the second port 12, the obtained equalized delay, and performs data communication with the optical network terminal 2 through the second port 12.

Reference may be to the foregoing method embodiment shown in FIG. 1 for a function and processing process of each module in the optical line terminal provided in this embodiment, and its implementation principle and technical effect are similar, which are not repeatedly described here.

Based on the foregoing embodiments, the second processing unit 14 is specifically configured to calculate, according to the first time and the second time, a difference between the first time and the second time, and obtain the equalized delay from the second port 12 to the optical network terminal 2 according to the difference.

Further, a manner that the second processing unit 14 of the optical line terminal 1 obtains, through the second port 12, the first time when the uplink message reaches the first port 11 may be selected according to system setting, which is not specifically limited in the embodiment, and only two specific application scenarios are used for specific description.

When the first port 11 and the second port 12 are both located at one same control board or different control boards of the optical line terminal 1, the first processing unit 13 is specifically configured to send the downlink message, which carries the first time, to the optical network terminal 2 through the first port 11, where the first time is the time when the uplink message sent by the optical network terminal 2 reaches the first port 11; and the second processing unit 14 is specifically configured to receive, from the second port 12, the uplink message returned by the optical network terminal 2, where the returned uplink message carries the first time.

When the first port 11 and the second port 12 are both located at one same control board of the optical line terminal 1, the first processing unit 13 is further configured to receive, from the first port 11, the uplink message returned by the optical network terminal 2, obtain the first time of receiving the uplink message, and send, to the second port 12, a notification message that carries the first time; and the second processing unit 14 is specifically configured to receive, from the second port 12, the notification message sent by the first port 11 and obtain the first time.

Reference may be to the foregoing method embodiment shown in FIG. 2 for the function and processing process of each module in the optical line terminal provided in this embodiment, and its implementation principle and technical effect are similar, which are not repeatedly described here.

Finally, it should be noted that the foregoing embodiments are merely provided for describing the technical solutions of the present invention, but are not intended to limit the present invention. It should be understood by persons of ordinary skill in the art that although the present invention has been described in detail with reference to the foregoing embodiments, modifications may still be made to the technical solutions described in the foregoing embodiments, or equivalent replacements may be made to part of the technical features in the technical solutions, as long as such modifications or replacements do not make the nature of corresponding technical solutions depart from the spirit and scope of the technical solutions of the embodiments of the present invention.

What is claimed is:

1. A method for data communication in an optical network system, wherein an optical line terminal in the optical network system is connected to at least one optical network terminal through a first port and a second port, the method comprising:
sending a downlink message to the optical network terminal through the first port;
receiving, from the second port, an uplink message returned by the optical network terminal, obtaining a second time of receiving the uplink message, and obtaining a first time when the uplink message reaches the first port;
obtaining an equalized delay from the second port to the optical network terminal according to the first time and the second time;
delivering, by the optical line terminal, the equalized delay from the second port after the optical line terminal is switched from the first port to the second port; and
performing data communication with the optical network terminal through the second port.

2. The method according to claim 1, wherein obtaining an equalized delay from the second port to the optical network terminal according to the first time and the second time, comprises:
calculating a difference between the first time and the second time according to the first time and the second time; and
obtaining the equalized delay from the second port to the optical network terminal according to the difference.

3. The method according to claim 2, wherein:
sending a downlink message to the optical network terminal through the first port comprises:
sending the downlink message, which carries the first time, to the optical network terminal through the first port, wherein the first time is the time when the uplink message sent by the optical network terminal reaches the first port; and
obtaining the first time when the uplink message reaches the first port comprises:
receiving, from the second port, the uplink message returned by the optical network terminal, wherein the returned uplink message carries the first time.

4. The method according to claim 2, further comprising:
receiving, from the first port, the uplink message returned by the optical network terminal, obtaining the first time of receiving the uplink message, and sending, to the second port, a notification message that carries the first time; wherein
the obtaining the first time when the uplink message reaches the first port comprises:
receiving, from the second port, the notification message sent by the first port, and obtaining the first time.

5. The method according to claim 1, wherein:
sending a downlink message to the optical network terminal through the first port comprises:
sending the downlink message, which carries the first time, to the optical network terminal through the first port, wherein the first time is the time when the uplink message sent by the optical network terminal reaches the first port; and
obtaining the first time when the uplink message reaches the first port comprises:
receiving, from the second port, the uplink message returned by the optical network terminal, wherein the returned uplink message carries the first time.

6. The method according to claim 1, further comprising:
receiving, from the first port, the uplink message returned by the optical network terminal, obtaining the first time of receiving the uplink message, and sending, to the second port, a notification message that carries the first time; and
wherein obtaining the first time when the uplink message reaches the first port comprises:
receiving, from the second port, the notification message sent by the first port, and obtaining the first time.

7. An optical line terminal, comprising a first processing unit and a second processing unit, wherein:
the first processing unit is connected to at least one optical network terminal through a first port, and is configured to send a downlink message to the optical network terminal through the first port; and
the second processing unit is connected to the at least one optical network terminal through a second port, and is configured to receive, through the second port, an uplink message returned by the optical network terminal, obtain a second time of receiving the uplink message, obtain a first time when the uplink message reaches the first port, and obtain an equalized delay from the second port to the optical network terminal according to the first time and the second time; and after the optical line terminal is switched from the first port to the second port, the optical line terminal delivers the equalized delay from the second port, and performs data communication with the optical network terminal through the second port.

8. The optical line terminal according to claim 7, wherein the second processing unit is configured to calculate, according to the first time and the second time, a difference between the first time and the second time, and obtain, according to the difference, the equalized delay from the second port to the optical network terminal.

9. The optical line terminal according to claim 8, wherein the first processing unit is specifically configured to send the downlink message, which carries the first time, to the optical network terminal through the first port, and the first time is the time when the uplink message sent by the optical network terminal reaches the first port; and
the second processing unit is specifically configured to receive, from the second port, the uplink message returned by the optical network terminal, wherein the returned uplink message carries the first time.

10. The optical line terminal according to claim 8, wherein the first processing unit is further configured to receive, from the first port, the uplink message returned by the optical network terminal, obtain the first time of receiving the uplink message, and send, to the second port, a notification message that carries the first time; and
the second processing unit is specifically configured to receive, from the second port, the notification message sent by the first port, and obtain the first time.

11. The optical line terminal according to claim 7, wherein:
the first processing unit is configured to send the downlink message, which carries the first time, to the optical network terminal through the first port, and the first time is the time when the uplink message sent by the optical network terminal reaches the first port; and
the second processing unit is configured to receive, from the second port, the uplink message returned by the optical network terminal, wherein the returned uplink message carries the first time.

12. The optical line terminal according to claim 7, wherein:
the first processing unit is further configured to receive, from the first port, the uplink message returned by the optical network terminal, obtain the first time of receiving the uplink message, and send, to the second port, a notification message that carries the first time; and
the second processing unit is configured to receive, from the second port, the notification message sent by the first port, and obtain the first time.

13. An optical network system, comprising an optical line terminal and an optical network terminal, wherein:
the optical line terminal is connected to at least one optical network terminal through a first port and a second port, and is configured to:
send a downlink message to the optical network terminal through the first port,
receive, from the second port, an uplink message returned by the optical network terminal,
obtain a second time of receiving the uplink message,
obtain a first time when the uplink message reaches the first port, and
obtain an equalized delay from the second port to the optical network terminal according to the first time and the second time; and
after the optical line terminal is switched from the first port to the second port, the optical line terminal delivers the equalized delay from the second port and performs data communication with the optical network terminal through the second port.

14. The optical network system according to claim 13, wherein the optical line terminal is configured to calculate, according to the first time and the second time, a difference between the first time and the second time, and obtain, according to the difference, the equalized delay from the second port to the optical network terminal.
